(19) United States
(12) Patent Application Publication
(10) Pub. No.: US 2012/0105313 A1
(43) Pub. Date: May 3, 2012

(54) PROJECTION DEVICE HAVING DISPLAY CONTROL FUNCTION AND METHOD THEREOF

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/980,337

(22) Filed: Dec. 29, 2010

(30) Foreign Application Priority Data
Oct. 29, 2010 (TW) 99137091

(51) Int. Cl. G09G 5/00

(52) U.S. Cl. 345/156

(57) ABSTRACT

A projection device having a display control function is provided. The projection device includes a document unit, a display unit, a lens module and a sensor unit. The sense unit senses distance and direction of movement of the projection device. The document unit scrolls through content of an opened document according the distance and direction of the sensed movement of the projection device from the sensor unit to select the content to be displayed, and control display of the selected content of a currently opened document on the display unit. The lens module projects the selected content currently displayed by the display unit. A method with a display control function is also provided.

### BACKGROUND

1. Technical Field

The present disclosure relates to projective devices and, particularly, to a projective device having a display control function and a method thereof.

2. Description of Related Art

Projection devices are widely used for projecting images obtained from an associated device such as a computer. When projecting images from a computer, the images are limited to whatever is currently viewable on the display of the computer. If there is more content available associated with what is currently displayed, such as other pages of a document, then a user must use controls on the computer, such as the arrow keys, to scroll to the other content, which is inconvenient, particularly in a darkened meeting room.

### BRIEF DESCRIPTION OF THE DRAWINGS

FIG. 1 is a block diagram of a hardware infrastructure of a projection device in accordance with an exemplary embodiment.

FIG. 2 shows a multi-page document file opened by a document unit of the projection device of FIG. 1.

FIG. 3 shows an image file opened by the document unit of the projection device of FIG. 1.

FIG. 4 illustrates scrolling to different views of the image file of FIG. 3 by the document unit of FIG. 3.

FIG. 5 is a block diagram of a hardware infrastructure of the projection device in accordance with another embodiment.

FIG. 6 is a flowchart of a method having display control function implemented by the projection device in accordance with an exemplary embodiment.

### DETAILED DESCRIPTION

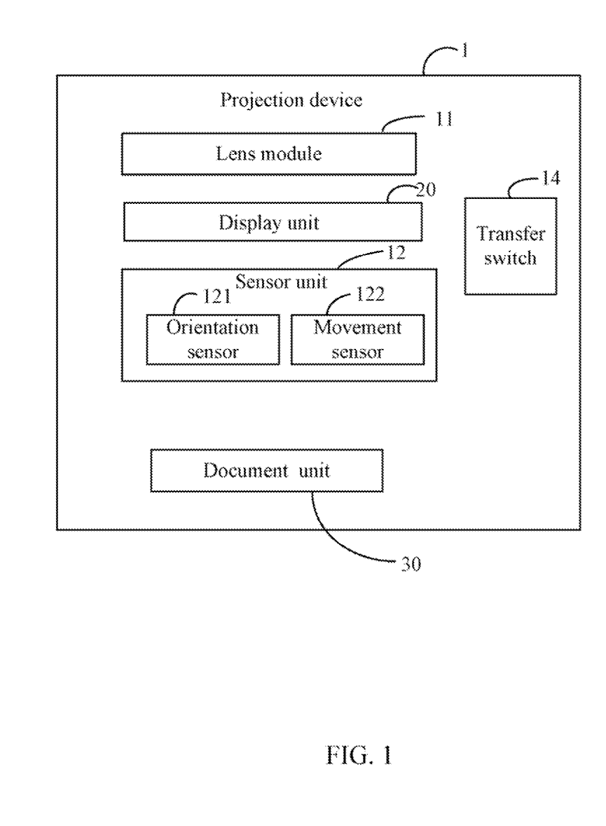

Referring to FIG. 1, a projection device 1 includes a document unit 30, a display unit 20, and a lens module 11. The document unit 10 is configured for opening documents, controlling to select content of an opened document and display of the selected content on the display unit. In one embodiment, the documents may be PDF files, WORD files, or image files etc. The selected content of the opened document may be content associated with one page of an opened document file, or a portion of an opened image file, etc. The lens module 11 is configured for projecting the selected content currently displayed by the display unit 20 onto a projection surface.

The projection device 1 further includes a sensor unit 12. The sensor unit 12 is configured for sensing distance and direction of movement of the projection device 1. In other words, the projection device 1 may be used in a manner similar to a pointer. However, in this case, movement of the projection device 1 is translated into commands to control scrolling through displayed content of the display unit 20. In this way, a user simply adjusts aim of the projection device 1 to view other parts of an opened document, which is more convenient than using control buttons on a keyboard. The document unit 30 is further configured for scrolling through the content of the opened document according to the distance and direction of the sensed movement of the projection device 1 from the sensor unit 12 to re-select the content to be displayed, and control display of the selected content of a currently opened document on the display unit 20.

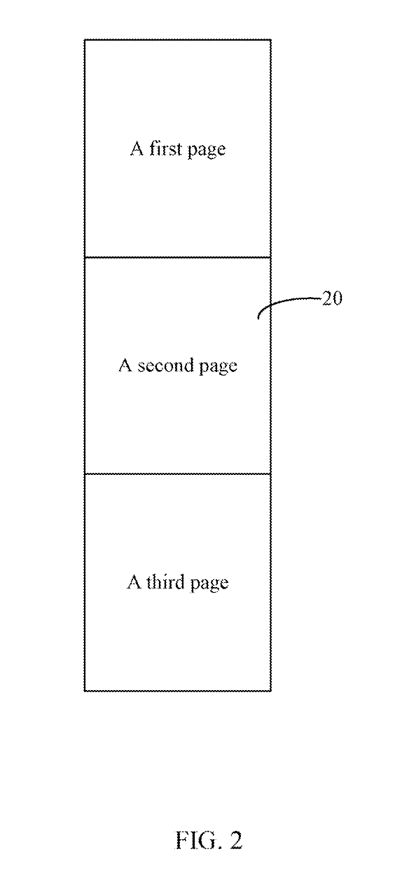

As shown in FIG. 2, the document unit 30 opens a file A, the display unit 20 displays content associated with a second page of the open file A. When aim of the projection device 1 is shifted up, the sensor unit 12 senses the distance and direction of the movement of the projection device 1. The document unit 30 scrolls through the viewable page of the open file A towards a previous page (i.e., a first page) according to the distance and direction of sensed movement of the projection device 1, thereby altering the projected view of the document.

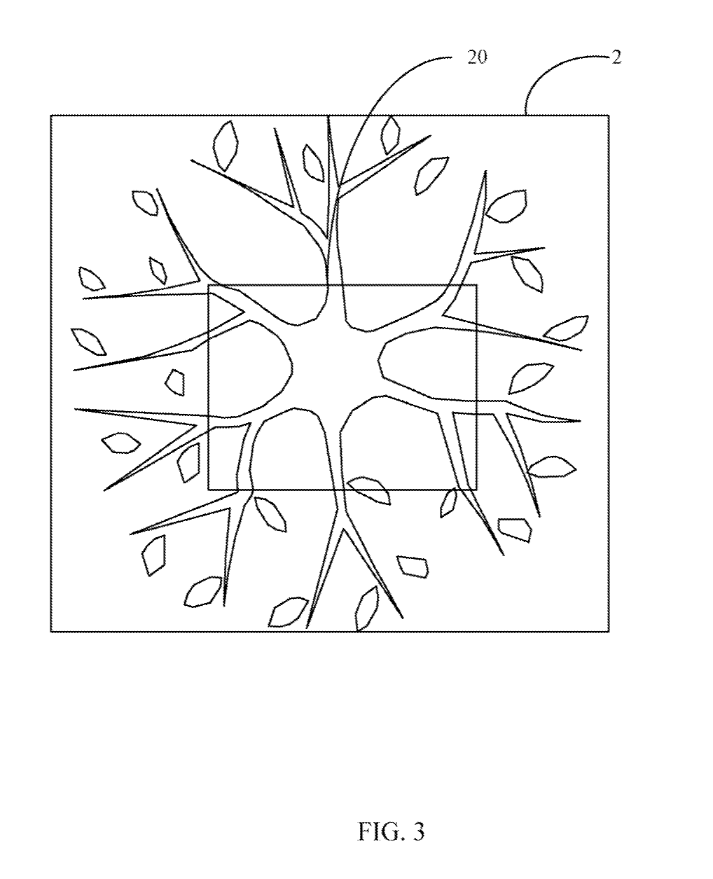

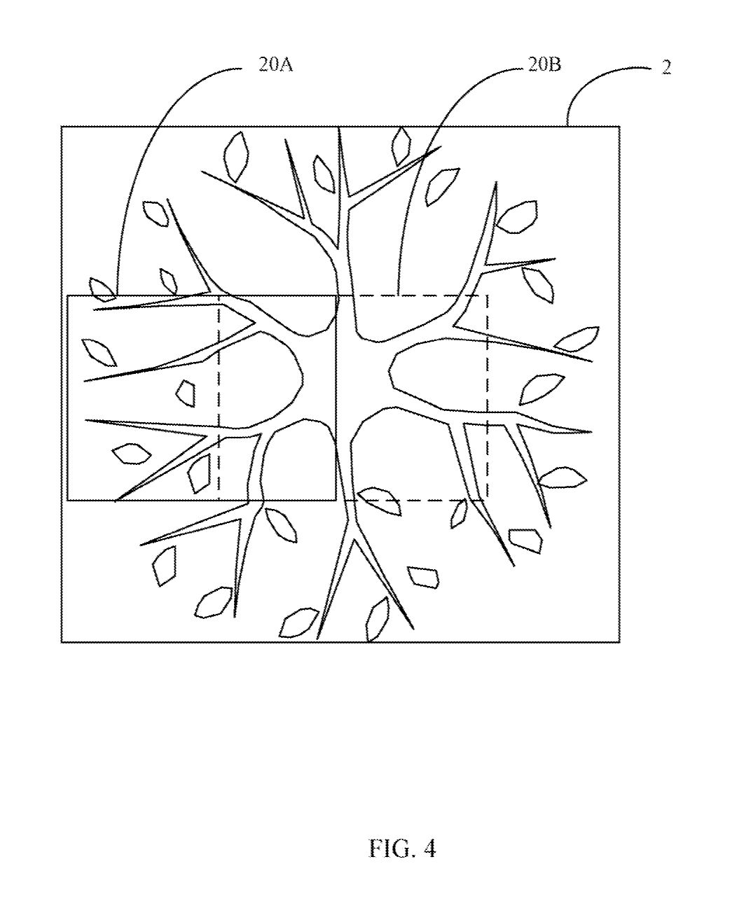

As shown in FIG. 3, due to the large size of an open image 2, the display unit 20 only displays a portion of the open image 2, e.g., a portion encircled by dotted-lines 20B. When the projection device 1 is moved towards the left side, the sensor unit 30 senses the distance and direction of the movement of the projection device 1. The document unit 10 scrolls to reveal an encircled portion 20A (shown in FIG. 4), of the image 2, to the left of the initially displayed portion according to the distance and direction of sensed movement of the projection device 1 from the sensor unit 12.

The sensor unit 12 includes an orientation sensor 121 and a movement sensor 122. The orientation sensor 121 is able to sense the direction of the movement of the projection device 1. In one embodiment, the orientation sensor 121 is an electronic compass. The movement sensor 122 is able to sense the distance of the movement of the projection device 1. In one embodiment, the movement sensor 122 is a combination of a tri-axial acceleration transducer and a gyroscope. In other embodiments, the movement sensor 122 may be a combination of three acceleration transducers and a gyroscope.

In another embodiment, the projection device 1 further includes a transfer switch 14 which switches the sensor unit 12 between an enabled state and a disabled state. For example, when the user does not want the image being scrolled through according to sensed movement of the projection device 1, the user operates the transfer switch 14 to switch the sensor unit 12 from the enabled state to the disabled state.

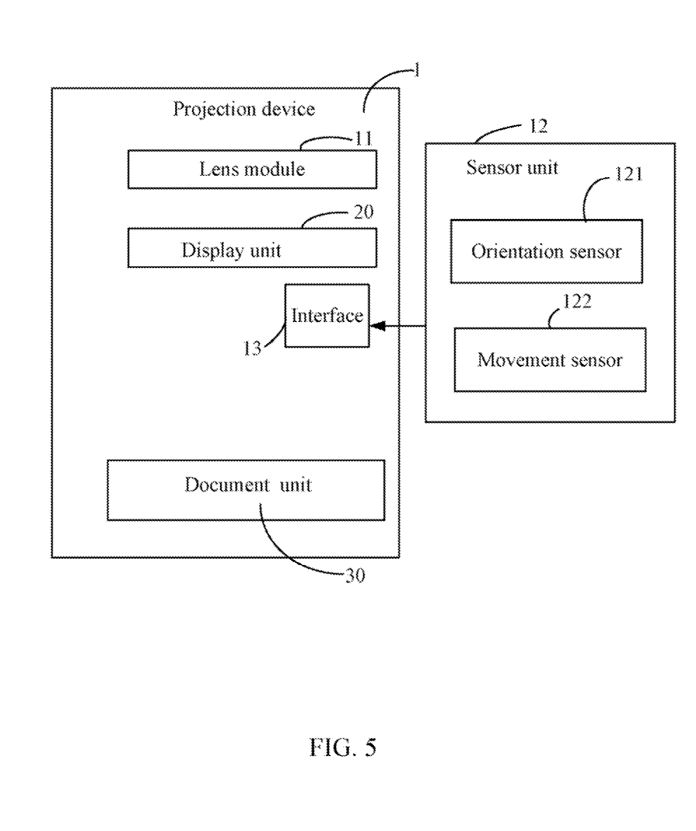

As shown in FIG. 5, in a second embodiment of the disclosure, the projection device 1 further includes an interface 13. The sensor unit 12 can be an independent sensor, which is connected to the projection device 1 through the interface 13.

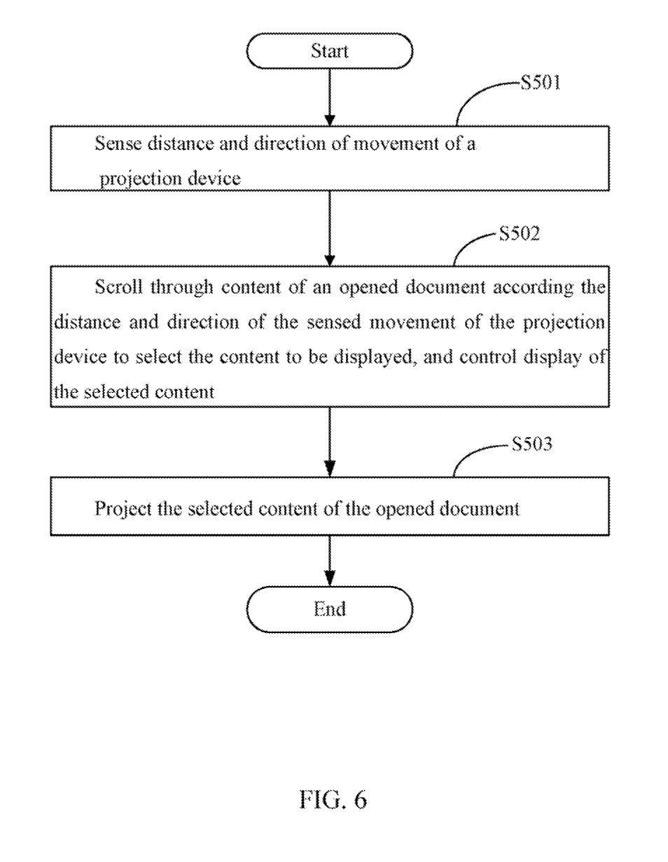

FIG. 6 is a flowchart of a method having a display control function implemented by the projection devices of FIGS. 1 and 5, in accordance with an exemplary embodiment.

In step S501, the sensor unit 12 senses distance and direction of the movement of the projection device 1.

In step S502, the document unit 10 scrolls through the content of an opened document according the distance and direction of the sensed movement of the projection device 1 from the sensor unit 12 to select the content to be displayed, and control display of the selected content of a currently opened document on the display unit 20.

In step S503, the lens module 11 projects the selected content of the opened document currently displayed by the display unit 20.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A projection device having a display control function, comprising:
a display unit;
a sensor unit to sense distance and direction of movement of the projection device;
a document unit to scroll through the content of an opened document according the distance and direction of the sensed movement of the projection device from the sensor unit to select the content to be displayed, and control display of the selected content of a currently opened document on the display unit; and
a lens module to project the selected content currently displayed by the display unit.

2. The projection device as described in claim 1, further comprising an interface, wherein the sensor unit is connected to the projection device through the interface when the sensor unit is an independent sensor.

3. The projection device as described in claim 1, wherein the sensor unit comprises an orientation sensor and a movement sensor, the orientation sensor is able to sense the direction of the movement of the projection device, and the movement sensor is able to sense the distance of the movement of the projection device.

4. The projection device as described in claim 3, wherein the orientation sensor is an electronic compass.

5. The projection device as described in claim 3, wherein the movement sensor is a combination of a tri-axial acceleration transducer and a gyroscope.

6. The projection device as described in claim 3, wherein the movement sensor is a combination of three acceleration transducers and a gyroscope.

7. The projection device as described in claim 1, further comprising a transfer switch which switches the sensor unit between an enable state and a disable state.

8. A method having a display control function implemented by a projection device, the method comprising:
sensing distance and direction of movement of the projection device;
scrolling through content of an opened document according the distance and direction of the sensed movement of the projection device to select the content to be displayed, and control display of the selected content of a currently opened document; and
projecting the selected content currently being displayed.
